(19) United States
(12) Patent Application Publication
(10) Pub. No.: US 2013/0149176 A1
(43) Pub. Date: Jun. 13, 2013

(54) ELECTRIC OIL PUMP FOR HYBRID VEHICLE

(71) Applicants: Jong Hyun Kim, Suwon-si (KR); Ki Nam Kim, Seongnam-si (KR); Young Chul Kim, Gwangmyeong-si (KR); Seung Jae Kang, Seoul (KR); Jae Shin Yi, Suwon-si (KR)

(72) Inventors: Jong Hyun Kim, Suwon-si (KR); Ki Nam Kim, Seongnam-si (KR); Young Chul Kim, Gwangmyeong-si (KR); Seung Jae Kang, Seoul (KR); Jae Shin Yi, Suwon-si (KR)

(73) Assignee: Hyundai Motor Company, Seoul (KR)

(21) Appl. No.: 13/492,468

(22) Filed: Jun. 8, 2012

(30) Foreign Application Priority Data
Dec. 9, 2011 (KR) 10-2011-0131869

(51) Int. Cl. F04C 11/00; F16F 15/12; F04C 15/00

(52) U.S. Cl. 417/410.4

(57) ABSTRACT

An electric oil pump apparatus for a hybrid vehicle, may include an electric motor having a motor rotor and a stator, wherein the motor rotor may be mounted on a rotary shaft, an oil pump having a pump rotor, wherein the pump rotor may be mounted on a rotary shaft, and a torsional damper installed on the rotary shaft of the motor rotor and a rotary shaft of the pump rotor between the motor rotor and the pump rotor.

### CROSS-REFERENCE TO RELATED APPLICATIONS

The present application claims priority to Korean Patent Application No. 10-2011-0131869 filed on Dec. 9, 2011, the entire contents of which is incorporated herein for purposes by this reference.

### BACKGROUND OF THE INVENTION

1. Field of the Invention

The present invention relates, in general, to an electric oil pump for a hybrid vehicle and, more particularly, to an electric oil pump for a hybrid vehicle which is configured using a switched reluctance motor (SRM).

2. Description of Related Art

Generally, a power train of a hybrid vehicle may substantially use a mechanism of an automatic transmission of the related art as it is. While such an automatic transmission includes a mechanical oil pump, a hybrid vehicle also includes an electric oil pump because when operation of an engine is stopped, the mechanical oil pump cannot create a hydraulic pressure required to operate the hybrid vehicle.

The electric oil pump includes a driving motor in which a rare-earth magnet is frequently used in order to improve the operation efficiency of the motor and reduce the size of the motor so as to minimize an influence upon a fuel ratio of a vehicle.

FIG. 1 illustrates the construction of the electric oil pump of the related art using a rare-earth magnet. The electric oil pump is configured such that a stator 502 is disposed around a motor rotor 500 having the rare-earth magnet, a rotary shaft 506 of the motor rotor 500 is supported by bearings 504 at opposite ends thereof, and a pump rotor 508 is connected to one end of the rotary shaft 506 to receive rotary force from the rotary shaft, so that the pump rotor 508 is rotated to pump oil following the revolution of the motor rotor 500.

While using the rare-earth magnet as such allows improvement in the efficiency and a compact design of the motor, supply and demand of the rare-earth magnet may be made unstable owing to external primary factors, thereby causing a material cost to increase.

Thus, in order to eliminate the dependency on the rare-earth magnet, a switched reluctance motor (SRM) or the like that does not use a permanent magnet can be used as a motor for driving an oil pump. The SRM drives a motor using magnetic resistance instead of a permanent magnet, so that it does not need the permanent magnet, but it has a problem in that a torque reply and noise disadvantageously increase when the motor rotates.

The electric oil pump operates within a section of an engine cycle such as “IDLE STOP” or the like where operation of an engine is stopped, and is very sensitive to noise so there is a need to deal with this problem.

It should be noted that what is described in the related art is merely mentioned to assist understanding of the background of the invention, and that it does not pertain to technologies of the prior art that have been known to persons skilled in the art.

The document of the prior art: Korean Unexamined Patent Publication No. 10-2009-0045990 A.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an electric oil pump for a hybrid vehicle which, in spite of using a switched reluctance motor (SRM), can reduce a torque reply when it is operated, reducing or preventing operation noise, and therefore eliminating the dependency on a rare-earth magnet to save manufacturing cost while securing quiet operation, thereby ultimately contributing to improvement in merchantability of a vehicle.

In an aspect of the present invention, an electric oil pump apparatus for a hybrid vehicle, may include an electric motor having a motor rotor and a stator, wherein the motor rotor is mounted on a rotary shaft, an oil pump having a pump rotor, wherein the pump rotor is mounted on a rotary shaft, and a torsional damper installed on the rotary shaft of the motor rotor and a rotary shaft of the pump rotor between the motor rotor and the pump rotor.

The oil pump may be composed of an internal gear pump with a pair of internal gears, and the pump rotor corresponds to an inner rotor part of the pair of gears that forms the internal gear pump.

The oil pump may include an inner rotor part and an outer rotor part provided around the inner rotor part such that the inner rotor part and the outer rotor part are meshed each other.

The electric motor is a switched reluctance motor (SRM), and the rotary shafts of the motor rotor and pump rotor are concentrically arranged with the torsional damper disposed therebetween.

The torsional damper may include first plate connected to the rotary shaft of the motor rotor such that a rotation direction is restricted with respect to the rotary shaft of the motor rotor, a second plate connected to the rotary shaft of the pump rotor such that a rotation direction is restricted with respect to the rotary shaft of the pump rotor, and an elastic member engaged between the first and second plates so as to elastically support a relative revolution between the first and second plates.

As set forth before, according to the present invention, the electric oil pump for a hybrid vehicle is configured such that in spite of using the SRM, a torque reply when it is operated is reduced to decrease or prevent the operation noise, eliminating the dependency on a rare-earth magnet to reduce a manufacturing cost and securing quiet operation, ultimately contributing to improvement in the merchantability of a vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view explaining a structure of an electric oil pump for a hybrid vehicle according to the related art.

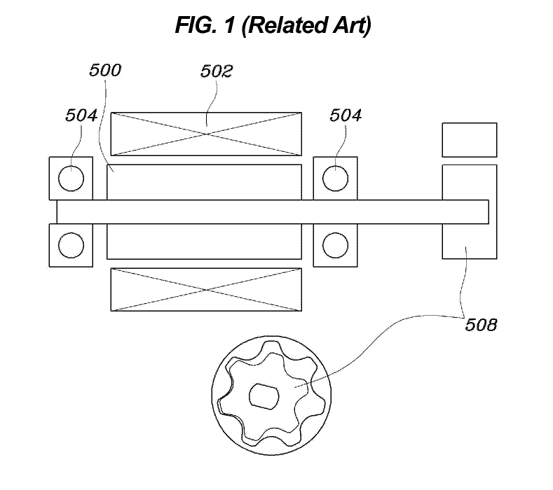

FIG. 2 is a view showing a structure of an electric oil pump for a hybrid vehicle according to an exemplary embodiment of the present invention.

FIG. 3 is a graphical diagram showing a comparison result of effects of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Reference will now be made in greater detail to a preferred embodiment of the invention, an example of which is illustrated in the accompanying drawings. Wherever possible, the same reference numerals will be used throughout the drawings and the description to refer to the same or like parts.

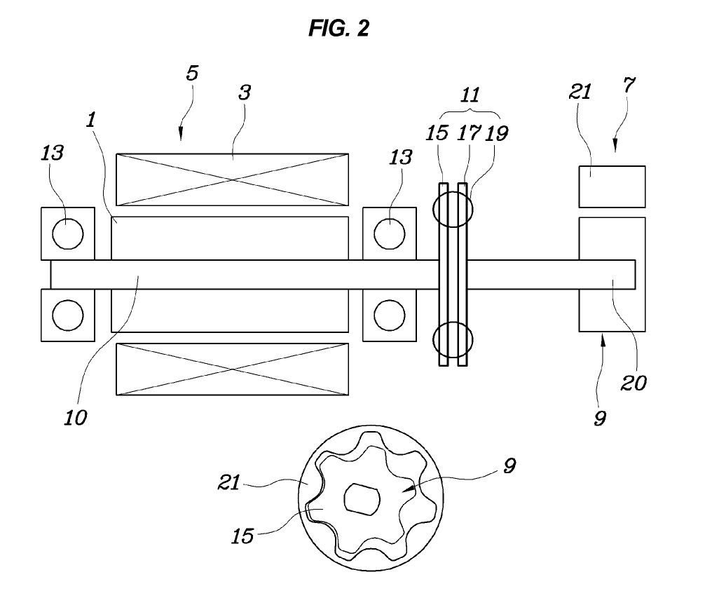

Referring to FIG. 2, an electric oil pump for a hybrid vehicle according to an exemplary embodiment of the present invention includes an electric motor 5, which has a motor rotor 1 and a stator 3, a pump rotor 9 of the oil pump 7, and a torsional damper 11 which is installed between a rotary shaft 10 of the motor rotor 1 of the electric motor 5 and a rotary shaft 20 of the pump rotor 9. Here, the electric motor 5 is a switched reluctance motor (SRM).

The SRM and the oil pump 7 are connected together through the torsional damper 11, so that a torque reply occurring when the SRM is operated is attenuated, allowing noise that may occur from the oil pump 7 because of the torque reply to be reduced or be prevented from occurring.

The rotary shafts 10 and 20 of the motor rotor 1 and pump rotor 1 are concentrically arranged with the torsional damper 11 disposed therebetween, wherein the rotary shaft 10 of the motor rotor 1 is supported by bearings 13 at opposite ends thereof.

The torsional damper 11 includes a first plate 15, which is connected to the rotary shaft 10 of the motor rotor 1 such that the rotary direction is restricted with respect to the rotary shaft 10 of the motor rotor 1, a second plate 17, which is connected to the rotary shaft 20 of the pump rotor 9 such that the rotary direction is restricted with respect to the rotary shaft 20 of the pump rotor 9, and an elastic member 19, which is installed between the first and second plates 15 and 17 so as to elastically support a relative revolution between the first and second plates 15 and 17.

The torsional damper 11 may be further configured such that a frictional surface is also provided so as to attenuate input revolution vibrations more quickly.

The oil pump 7 includes an internal gear pump with a pair of internal gears, and the pump rotor 9 corresponds to an inner rotor part 15 of the pair of gears that forms the internal gear pump.

An outer rotor part 21 is provided around the inner rotor part 15 such that it meshes with the inner rotor part 15 while forming an internal gear therewith. A pump casing having oil inlet and outlet is provided around the outer rotor part.

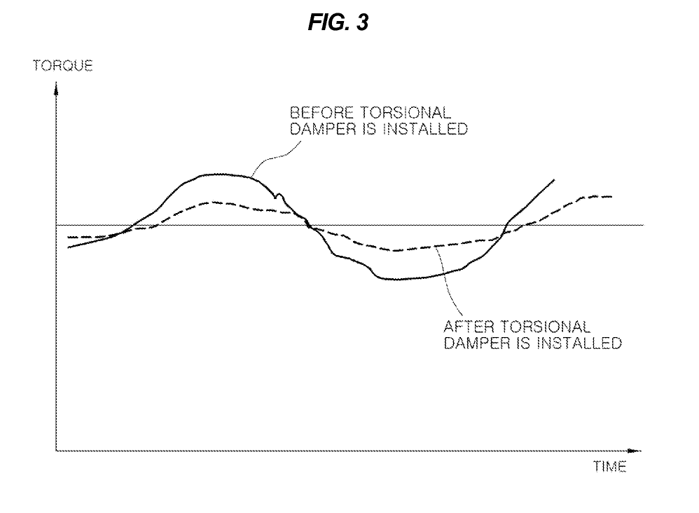

According to the electric oil pump 7 constructed as described above, when the SRM is operated, the pump rotor 9 is rotated to pump oil, and a torque reply occurring from the SRM is absorbed in and attenuated by the torsional damper 11, so that as shown in FIG. 3, the amplitude of the revolution vibrations is considerably reduced by the torsional damper 11, resulting in a great reduction in or prevention of a rattling noise that is caused by meshing sound between the inner and outer rotor parts, thereby ensuring quiet operation.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An electric oil pump apparatus for a hybrid vehicle, comprising:
an electric motor having a motor rotor and a stator, wherein the motor rotor is mounted on a rotary shaft;
an oil pump having a pump rotor, wherein the pump rotor is mounted on a rotary shaft; and
a torsional damper installed on the rotary shaft of the motor rotor and a rotary shaft of the pump rotor between the motor rotor and the pump rotor.

2. The electric oil pump apparatus for the hybrid vehicle according to claim 1, wherein the oil pump is composed of an internal gear pump with a pair of internal gears, and the pump rotor corresponds to an inner rotor part of the pair of gears that forms the internal gear pump.

3. The electric oil pump apparatus for the hybrid vehicle according to claim 1, wherein the oil pump includes an inner rotor part and an outer rotor part provided around the inner rotor part such that the inner rotor part and the outer rotor part are meshed each other.

4. The electric oil pump apparatus for the hybrid vehicle according to claim 1, wherein the electric motor is a switched reluctance motor (SRM), and the rotary shafts of the motor rotor and pump rotor are concentrically arranged with the torsional damper disposed therebetween.

5. The electric oil pump apparatus for the hybrid vehicle according to claim 4, wherein the oil pump is composed of an internal gear pump with a pair of internal gears, and the pump rotor corresponds to an inner rotor part of the pair of gears that forms the internal gear pump.

6. The electric oil pump apparatus for the hybrid vehicle according to claim 4, wherein the oil pump includes an inner rotor part and an outer rotor part provided around the inner rotor part such that the inner rotor part and the outer rotor part are meshed each other.

7. The electric oil pump apparatus for the hybrid vehicle according to claim 1, wherein the torsional damper includes:
a first plate connected to the rotary shaft of the motor rotor such that a rotation direction is restricted with respect to the rotary shaft of the motor rotor;
a second plate connected to the rotary shaft of the pump rotor such that a rotation direction is restricted with respect to the rotary shaft of the pump rotor; and
an elastic member engaged between the first and second plates so as to elastically support a relative revolution between the first and, second plates.

8. The electric oil pump apparatus for the hybrid vehicle according to claim 7, wherein the oil pump is composed of an internal gear pump with a pair of internal gears, and the pump rotor corresponds to an inner rotor part of the pair of gears that forms the internal gear pump.

9. The electric oil pump apparatus for the hybrid vehicle according to claim 7, wherein the oil pump includes an inner rotor part and an outer rotor part provided around the inner rotor part such that the inner rotor part and the outer rotor part are meshed each other.
